(19) United States
(12) Patent Application Publication
(10) Pub. No.: US 2014/0279321 A1
(43) Pub. Date: Sep. 18, 2014

(54) METHOD AND SYSTEM OF CHARGE DISTRIBUTION IN A TRANSPORTATION MANAGEMENT COMPONENT

(71) Applicants: Murugesh Karunamurthy, Bangalore (IN); Vineet Vivekanand Kulkarni, Bangalore (IN)

(72) Inventors: Murugesh Karunamurthy, Bangalore (IN); Vineet Vivekanand Kulkarni, Bangalore (IN)

(73) Assignee: SAP AG, Walldorf (DE)

(21) Appl. No.: 13/839,431

(22) Filed: Mar. 15, 2013

(51) Int. Cl. G06Q 50/30; G06Q 30/04

(52) U.S. Cl. CPC G06Q 50/30; G06Q 30/04
USPC 705/34

(57) ABSTRACT

A method and system of distributing costs in a transportation management system is provided. A charge element for a cost to be applied to a transportation invoice is received, wherein the charge element identifies a charge amount. Then, for each distribution item, a distribution element corresponding to the distribution item is created in response to a determination that the charge element is applicable to the distribution item, wherein each distribution item corresponds to an item transported in a shipment associated with the transportation invoice. A quantity type identified in a distribution rule for the charge element is determined. Then quantities of the quantity type are obtained for each distribution element. These quantities are summed into an aggregate quantity. Then, for each distribution element, a cost for the charge element equal to a quantity of the distribution element divided by the aggregate quantity multiplied by the charge amount is allocated.

### TECHNICAL FIELD

This document generally relates to methods and systems for use with transportation management components. More specifically, this document relates methods and of charge distribution in a transportation management component.

### BACKGROUND

Enterprise resource planning (ERP) systems allow for the integration of internal and external management information across an entire organization, including financial/accounting, manufacturing, sales and service, customer relationship management, and the like. The purpose of ERP is to facilitate the flow of information between business functions inside the organization and management connections to outside entities. It is common for a transport management component to interact with an ERP component. The transportation management component allows for planning and decision making regarding transport schemes. This allows an enterprise to properly manage transportation of goods.

### BRIEF DESCRIPTION OF DRAWINGS

The present disclosure is illustrated by way of example and not limitation in the figures of the accompanying drawings, in which like references indicate similar elements and in which:

FIG. 1 is a block diagram of an application system, in accordance with an example embodiment.

FIG. 2 is a diagram illustrating a transportation management component in accordance with an example embodiment.

FIG. 3 is a diagram illustrating data structures, in accordance with an example embodiment, used to perform flat rate allocation.

FIG. 4 is a sequence diagram illustrating method, in accordance with an example embodiment, of charge distribution.

FIG. 5 is a flow diagram illustrating a method, in accordance with another example embodiment, of distributing charges.

FIG. 6 is a screen capture illustrating a method, in accordance with an example embodiment, of defining a cost distribution profile.

FIG. 7 is a screen capture illustrating a method, in accordance with an example embodiment, of displaying a freight order.

FIG. 8 is a screen capture illustrating a method, in accordance with an example embodiment, of displaying stages of a freight order.

FIG. 9 is a screen capture illustrating a method, in accordance with an example embodiment, of displaying a freight settlement document.

FIG. 10 is a screen capture illustrating a method, in accordance with an example embodiment, of displaying a distribution document.

FIG. 11 is a screen capture illustrating a method, in accordance with another example embodiment, of displaying items in a freight order.

FIG. 12 is a screen capture illustrating a method, in accordance with another example embodiment, of displaying charges in a freight settlement document.

FIG. 13 is a screen capture illustrating a method, in accordance with another example embodiment, of displaying a distribution document.

FIG. 14 is a flow diagram illustrating a method, in accordance with an example embodiment, of distributing costs in a transportation management system.

FIG. 15 is a block diagram of a computer processing system at a server system, within which a set of instructions may be executed for causing the computer to perform any one or more of the methodologies discussed herein.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques have not been shown in detail. In an example embodiment, charges are distributed in a transportation management component. A charge element for a cost to be applied to a transportation invoice is received, wherein the charge element identifies a charge amount. Then, for each distribution item, a distribution element corresponding to the distribution item is created in response to a determination that the charge element is applicable to the distribution item, wherein each distribution item corresponds to an item transported in a shipment associated with the transportation invoice. A quantity type identified in a distribution rule for the charge element is determined. Then quantities of the quantity type are obtained for each distribution element. These quantities are summed into an aggregate quantity. Then, for each distribution element, a cost for the charge element equal to a quantity of the distribution element divided by the aggregate quantity multiplied by the charge amount is allocated.

While the following description will describe various embodiments related to an enterprise resource planning (ERP) system and a transportation management component, one of ordinary skill in the art will recognize that the claims should not be limited to merely ERP embodiments and transportation management components, as the solution described herein could apply to other systems such as Customer Relationship Management (CRM) systems, Supplier Relationship Management systems (SRM), or any other system that manages transportation.

Product manufacturing involves various costs, such as raw material cost, design and development cost, painting costs, etc. During the manufacture process, the product may be transferred to different locations performing these activities. At each location, the product cost is maintained in ERP as a material price. For a manufacturer, it is very important that the transportation cost be allocated to the respective price of the material at every location, in order to properly track overall costs.

During transportation of these goods, a carrier renders a variety of services to make sure that the goods reach their destination without any damage. The goods are usually packaged during transfer and then loaded in a container. Based on the agreement with the carrier, the shipper can calculate various charges, including container handling charges (applied to each container), packaging charges (applied to the relevant packages), basic freight (applied to each product), stop charges (Applied at each stage of transportation), and document fees (Applied to each freight order). A shipper plans his order such that he gets the optimal price from the carrier. In an example embodiment, an automated system of allocation allows for the distribution of the various charges to each product in the freight order.

FIG. 1 is a block diagram of an application system, in accordance with an example embodiment. The application system 100 comprises different heterogeneous software and/or hardware components 102 to 116, which are connected to each other as shown by the solid lines in FIG. 1, and which may operate together in the application system 100 to process, for example, a business scenario. The application system 100 may comprise an enterprise resource planning (ERP) system 102. The ERP system 102 may integrate internal and external management information across an entire organization, embracing different activities and/or services of an enterprise. The ERP system 102 automates the activities and/or services with an integrated computer-based application. The ERP system 102 can run on a variety of hardware and/or network configurations, typically employing a database to store its data. The ERP system 102 may be associated with (e.g., directly or indirectly connected to and/or in (networked) communication with) a business intelligence (BI) component 104, a transportation management component 106, one or more third parties 108, a supply chain management (SCM) component 110, and/or a SRM component 112. The SRM component 112 and/or the SCM component 110 may further be associated with at least one proprietary service 114. The transportation management component 106 may reside between the ERP system 102 and a warehouse/distribution component 116. A typical scenario would include both inbound (procurement) and outbound (shipping) orders to be evaluated by the transportation management component 106, offering the user various suggested routing solutions. These solutions are evaluated by the user for reasonableness. The best mode and least expensive provider may be selected. Once the best provider is selected, the solution typically generates electronic load tendering and track/trace to execute the optimized shipment with the selected carrier, and later to support freight audit and payment (settlement process).

The BI component 104 may provide historical, current, and predictive views of business processes and/or business scenarios, for example, performed on the ERP system 102. Common functionality of business intelligence technologies may comprise reporting, online analytical processing, analytics, data mining, business performance management, benchmarking, text mining, and/or predictive analytics. The functionality may be used to support better decision making in the ERP system 102. The SCM component 110 may manage a network of interconnected businesses involved in the provision of product and/or service packages called for by end consumers such as the ERP system 102. The SCM component 110 may span movement and storage of raw materials, work-in-process inventory, and finished goods from point of origin to point of consumption (also referred to as a supply chain). The SRM component 112 may specify collaborations with suppliers that are vital to the success of the ERP system 102 (e.g., to maximize the potential value of those relationships). All of these systems may be integrated via a PI component 118.

FIG. 2 is a diagram illustrating a transportation management component in accordance with an example embodiment. The transportation management component 200 may comprise three sub-components, including request management 202, dispatching and execution 204, and transportation charge management 206. A request 208 to transport goods may be received by request management 202. This request 208 may be in the form of, for example, a forwarding order (FWO), order-based transportation requirements (OTR), and/or delivery-based transportation requirements (DTR). A freight unit building component 210 may then build multiple freight units 212A-212C based on these requirements. Each freight unit 212A-212C represents the basic planning element in the transportation management component 200, and represents units of freight to be moved. This may be, for example, a pallet or container containing one or more items.

The freight units 212a-212c are then passed to an optimizer/planner 214 within dispatching and execution 204. The optimizer/planner 214 allows for manual or optimizer-supported load building and planning. This often will take into account capacity information 216 to determine the best possible routes, services, and modes of transportation, based on a booking 218. The result of planning, consolidation of freight units 212a-212c on a vehicle, booked capacity, and scheduled means of transport may be stored in a freight order 220. The freight order 220 is passed to transportation charge management 206, which generates a freight settlement document 222 based on the freight order 220, and a forward settlement document 224, which is the customer invoice for the transportation services. The forward settlement document 224 may take into account a freight agreement 226, which includes such items as a transportation charge calculation sheet, rate, and scale. An accounting document 228 may then be generated for internal settlement.

The final settlement documents, including freight settlement document 222, forward settlement document 224, and accounting document 228 may contain charges at various levels. One issue that arises is how to distribute transportation charges among the various items within a freight unit 212A-212C. For example, a particular freight unit 212A may contain various items, of different sizes and shapes. A problem is encountered when attempting to allocate fuel cost of truck delivery to the suppliers (or customers) of the individual units. Additionally, a particular freight unit 212A may not contain all the same items for the entire length of its journey. There may be multiple stages or legs of a journey of the freight unit 212A, and some items may be removed (or added) at intermediate points along the journey. This makes the determination of how to allocate transportation costs even more challenging.

In an example embodiment, a flat rate allocation is performed for charge distributions. For any given transportation cost (e.g., container handling charge, packaging charge, basic freight, stop charge, fuel cost, document fee, mileage, weight surcharge, etc.), the items (or other reference points, which may collectively be referred to as distribution items) to which the transportation cost need to be allocated can be determined. The charges at various levels of the freight settlement document 222 can be mapped against a header/item hierarchy. Once this is performed, a distribution quantity (which could be weight, volume, or some other metric specified by a user) of the distribution item can be identified. The cost can then be distributed to various distribution items using this information.

FIG. 3 is a diagram illustrating data structures, in accordance with an example embodiment, used to perform flat rate allocation. A host business object 300 contains a trigger action 302 to distribute costs. This trigger action 302 may be enabled for various types of documents, such as freight order documents 220 and freight settlement documents 222. A data access object 304 is responsible for retrieving host related data using a host related data retriever 306. The term “host” in this context refers to the document, such as a freight order document 220 or freight settlement document 222. The information may include, for example, various stages (e.g., leas) of the transport, information of the document itself, such as carrier and source and destination location, and item information. A preprocessing interface 308 enables preprocessing steps necessary for creation of nodes in a cost distribution dependent object 310, wherein the cost distribution nodes are created, updated and deleted. This creates a tree or tree-like data structure with a number of nodes for each freight unit 212a-212c, each node representing either a root or an item in the freight unit 212a-212c. A cost distribution engine 312 then can apply a direct cost allocation sequence to directly allocate the transportation costs to the various nodes (and therefore, to the individual items with the freight unit 212A-C).

FIG. 4 is a sequence diagram illustrating method, in accordance with an example embodiment, of charge distribution. The method 400 utilizes various objects within a transportation management component 200, including a consumer business object 402, a host business object action 404, a data access object (DAO) base 406, a factory class 408, a data object (DO) action 410, and a cost distribution engine 412. At operation 414, the consumer business object 402 may make a call to distribute costs for a freight order 220 to the host business object action 404. The host business object action 404 then makes a call at operation 416 to the factory class 108 to retrieve a data object instance for the host. At operation 418, the created data object instance is returned to the host business object action 404.

At operation 420, the host business object action 404 sends a request 208 for information about the freight order 220 to the data access object base 406. At operation 422, this information may be returned to the host business object action 404. This information may include information about the “root” of the order, which represents the highest level of the hierarchy of the order, as well as information about items and stages of the order. Included in information may be the resolution bases of various charges (charge elements), as well as general information such as a calculation level. The resolution base is an indication of at what level a particular charge item is assigned. Examples include booking, container, main item, package, product, resource, root, and stage. Calculation level is a general setting defining the level at which the system will calculate the charges, for example at the header level, item level, or stage level.

At operation 424, a request 208 to distribute the charges is sent to the data object action 410. At operation 426, the data object action 410 creates unallocated distribution elements. At operation 428, the data object action 410 requests a distribution method instance from the factory class 408. At operation 430, the factory class 408 creates a distribution method instance and at operation 432 the distribution method instance is passed to the host business object action 404.

At operation 434, the host business object action 404 sends a request 208 to allocate charges to the cost distribution engine 412. At operation 436, the cost distribution engine 412 allocates costs to the distribution elements, and at operation 438 these allocated distribution elements are passed to the data access object base 406. At operation 440, the data access object base 406 passes the allocated distribution elements to the host business object action 401, which updates a root element at operation 442 and passes the new distribution root to the consumer business object 402 at operation 444.

FIG. 5 is a flow diagram illustrating a method, in accordance with another example embodiment, of distributing charges. In one example embodiment, this method 500 may be performed by the cost distribution engine 412 of FIG. 4, but this flow diagram is not intended to be limited to such implementations. This method 500 specifically uses the resolution base and calculation level information as described above with respect to operation 422 of FIG. 4 in making its determinations. This method 500 may be performed for each charge element, which represents a charge to be applied to one or more of a series of distribution items. A distribution item is any item to which a charge could potentially be applied, such as an item, container, or stage.

Generally the method 500 involves two main aspects, the creation of distribution elements, which represent distribution items to which charges should be allocated, and the allocation of distribution amounts to the distribution items.

At operation 502, it is determined if the resolution base for the charge element is set at the stage level. If so, then at operation 504 a distribution element is created for each distribution item that travels in a stage that the charge element refers. At operation 506, it is determined if the resolution base for the charge element is set at the root level. If so, then at operation 508 it is determined if the calculation level is set at the stage, the header level, or the item level. If at the stage level, then the process proceeds to operation 504. If at the header level, then at operation 510 the charge applies to everything and distribution elements are created for all distribution items. If at the item level, then at operation 512 distribution elements are created for all distribution items within the hierarchy (either parent or child) of the item to which the charge element refers.

If at operation 506 it was determined that the resolution base for the charge element was not set at the root level, then it must be set at what is known as the order item level. Order item refers to any of the “item” or “item-related” categories specified earlier as being possible settings for resolution bases. This may include, for example, booking, container, main item, package, product, and resource. In such a case, at operation 514 it is determined if the calculation level is set at the stage level. If so, then the process proceeds to operation 504. If not, then the process proceeds to operation 512.

This completes the first main aspect of the method 500, namely the creation of distribution elements. The rest of the method 500 pertains to the second main aspect, namely the allocation of distribution amounts to the created distribution items. This aspect is repeated for each charge element.

At operation 516, a distribution rule for the charge element is retrieved. The distribution rule will specify the type of quantity that the charge should be applied to. For example, the distribution for a fuel surcharge could be based on weight, in which case the type “weight” will be specified in the distribution rule. In another example, the distribution for a packing charge could be based on volume, in which case the type “volume” will be specified in the distribution rule.

At operation 518, for each distribution item, the quantities (of the type specified in the distribution rule) are determined. This may be read from a communication structure. Thus, if the distribution rule specifies weight, then the weights of each distribution item may be determined at this operation. At 520, an aggregated quantity may be determined for all of the distribution elements for this charge element. Thus, in the weight example, this operation may add up all of the weights of the distribution elements for this charge element.

At operation 522, for each distribution element, a charge may be distributed to the distribution element based on the formula Distribution Amount=Item Quantity/Aggregated Quantity*Charge element amount. Thus, for example, if the charge item is a fuel charge of $1000 and a particular item having a distribution element weighs 10 pounds and the total aggregated weight of the distribution elements is 500 pounds), then a fuel charge of $20 may be assigned to the distribution element corresponding to this particular item.

In another example embodiment, the direct distribution method described above with respect to FIG. 5 may be run multiple times on a hierarchy. The hierarchy may include two or more levels of items, including distribution items and parent items for the distribution items, and the direct distribution method may be run at least one time on each level. This can be helpful in cases where parent items have a feature that can impact cost.

One common example of a case where a parent item has a feature that can impact cost is the tare weight of containers. While individual distribution items may have their own weights that can affect costs, the containers that hold the combination of individual distribution items may also have their own weights. In such a case, the parent items may first be designated as transient distribution items. These transient distribution items will be treated as distribution items for a first pass of the direct distribution method, but not in subsequent passes. Thus, in a first pass, costs are distributed among one level of the transient distribution items. For example, if there are two containers in a shipment, and each container includes multiple products (distribution items), then the containers may be labeled as transient distribution items and in the first pass the direct distribution method may distribute the costs to the containers themselves. Then, in a second pass, costs are distributed from each transient distribution item to its child distribution items. Thus, in the example discuss above, the costs that were assigned to the first container in the first pass are then distributed to the distribution items within the first container in the second pass. Likewise, the costs that were assigned to the second container are then distributed to the distribution items within the second container. This may be known as a hierarchical distribution method.

FIG. 6 is a screen capture illustrating a method, in accordance with an example embodiment, of defining a cost distribution profile. In the user interface 600, the user may define a profile for the distribution of costs of transportation in a transportation management system. The user may select a distribution method 602. Here, the user has selected a direct distribution method 602, which corresponds to the method described above with respect to FIG. 5. The user may also select a distribution rule 604, which here the user has selected as gross weight. The user may also select a distribution level 606, which is also known as the calculation level.

The user may then proceed to create forwarding orders in a transportation management system. In an example, the user may create one forwarding order travelling from location A to location C, and another aiding order travelling from location B to location C. Then the user may plan the forwarding orders to create a freight order 220. FIG. 7 is a screen capture illustrating a method, in accordance with an example embodiment, of displaying a freight order. The freight order 700 includes an item hierarchy 702 with references to the two forwarding orders 704A, 704B. Each forwarding order 704A, 704B may contain one or more items 706A, 706B. Here only one item 706A, 706B is depicted for each forwarding order 704A, 704B, but there may be any number of items per forwarding order 704A, 704B. Notably, there is also a column 708 displaying the gross weight of each item.

The user may also view the freight order based on stages. FIG. 8 is a screen capture illustrating a method, in accordance with an example embodiment, of displaying stages of a freight order. Here, within the user interface 800, the user has selected a stages tab 802, which brings up a window 804 that includes information about each stage, including, notably, distance 806 of the stage. The distance 806 may be useful in distributing charges that are based on distance.

Charges may then be calculated in a freight order UI, after which the freight order may be saved. At this point, the user may create a settlement document and save the settlement document. FIG. 9 is a screen capture illustrating a method, in accordance with an example embodiment, of displaying a freight settlement document. Within the freight settlement document 900, one or more charge items 902 may be displayed. The corresponding rate amounts 904 are also displayed. This information may be used later in the process to determine how much to apply to each distribution element.

When a save is performed on the freight settlement document 900, a cost distribution method may be triggered. This cost distribution method may be performed, for example, in line with FIG. 5 as described above. The result of this process is a distribution document. FIG. 10 is a screen capture illustrating a method, in accordance with an example embodiment, of displaying; a distribution document. The distribution document 1000 includes distribution amounts 1002 for each of the charges 1004. Also shown is a distribution percentage 1006, which represents the percentage of the total distribution for the charge.

In another example, the user creates a sales order in an ERP system 102. An outbound delivery with reference to the created sales order, which in turn creates delivery-based transportation requests in the transportation management system. Delivery-based transportation requests can then be used to create a freight order. The freight order user interface may be used to calculate charges 1004, and the freight order may be saved. The user may then click on follow up and create a settlement document. When the settlement document is saved, the cost distribution method may be triggered.

FIG. 11 is a screen capture illustrating a method, in accordance with another example embodiment, of displaying items in a freight order. This diagram illustrates a hierarchy of items. In such a case, it may be beneficial to execute the hierarchical distribution method as described earlier. Here, the freight order 1100 includes an item hierarchy 1102, including outbound deliveries 1104A, 1104B, each having items 1106A-1106D. These are delivery items. Thus, the outbound deliveries 1104A, 1104B may first be designated as transient distribution items, and the costs distributed to these outbound deliveries 1104A, 1104B. Then the costs distributed to outbound delivery 1104A may then be distributed among its child distribution items 1106A, 1106B, while the costs attributed to outbound delivery 1104B may be distributed among its child distribution items 1106C, 1106D.

FIG. 12 is a screen capture illustrating a method, in accordance with another example embodiment, of displaying charges in a freight settlement document. The freight settlement document 1200 includes a charge hierarchy 1202 including multiple charges 1204.

FIG. 13 is a screen capture illustrating a method, in accordance with another example embodiment, of displaying a distribution document. The distribution document 1300 includes distribution amounts 1302 for each of the charges 1304. Also shown is a distribution percentage 1306.

FIG. 14 is a flow diagram illustrating a method 1400, in accordance with an example embodiment, of distributing costs in a transportation management system. At 1402, a charge element for a cost to be applied to a transportation invoice is received, wherein the charge element identifies a charge amount. At 1404, for each distribution item, a distribution element corresponding to the distribution item is created, in response to a determination that the charge element is applicable to the distribution item, wherein each distribution item corresponds to an item transported in a shipment associated with the transportation invoice.

It should be noted that the term “shipment” as used in this disclosure shall be interpreted broadly to mean any transfer of items from one location to another, no matter the form of the transfer. Examples include boat transportation, air transportation, ground transportation, etc. In one example embodiment, the transfer taking place need not even be physical, such as in the transfer of information from one location to another via electronic messaging.

It should be noted that the term “applicable”, as used in this document, means that the charge element is defined in a manner that makes it relevant to the corresponding distribution item. Relevancy may be determined, for example, using the method described in FIG. 5.

At 1406, a quantity type identified in a distribution rule 604 for the charge element is determined. At 1408, quantities of the quantity type are obtained for each distribution element. At 1410, the quantities for all of the distribution elements are summed to calculate an aggregate quantity. At 1412, for each distribution element, a cost for the charge element is allocated, equal to a quantity of the distribution element divided by the aggregate quantity multiplied by the charge amount.

FIG. 15 is a block diagram of a computer processing system 1500 at a server system, within which a set of instructions may be executed for causing the computer to perform any one or more of the methodologies discussed herein.

Embodiments may also, for example, be deployed by Software-as-a-Service (SaaS), application service provider (ASP), or utility computing providers, in addition to being sold or licensed via traditional channels. The computer may be a server computer, a personal computer (PC), a tablet PC, a set-top box (STB), a personal digital assistant (PDA), cellular telephone, or any processing device capable of executing a set of instructions (sequential or otherwise) that specify actions to be taken by that device. Further, while only a single computer is illustrated, the term “computer” shall also be taken to include any collection of computers that individually or jointly execute a set (or multiple sets) of instructions to perform any one or more of the methodologies discussed herein.

The example computer processing system 1500 includes processor 1502 (e.g., a central processing unit (CPU), a graphics processing unit (CPU) or both), main memory 1504 and static memory 1506, which communicate with each other via bus 1508. The processing system 1500 may further include graphics display unit 1510 (e.g., a plasma display, a liquid crystal display (LCD) or a cathode ray tube (CRT)). The processing system 1500 also includes alphanumeric input device 1512 (e.g., a keyboard), a cursor control device 1514 (e.g., a mouse, touch screen, or the like), a storage unit 1516, a signal generation device 1518 (e.g., a speaker), and a network interface device 1520.

The storage unit 1516 includes machine-readable medium 1522 on which is stored one or more sets of instructions 1524 and data structures (e.g., software) embodying or utilized by any one or more of the methodologies or functions described herein. The instructions 1524 may also reside, completely or at least partially, within the main memory 1504 and/or within the processor 1502 during execution thereof by the processing system 1500, the main memory 1504 and the processor 1502 also constituting machine-readable, tangible media.

The instructions 1524 may further be transmitted or received over network 1526 via a network interface device 1520 utilizing any one of a number of well-known transfer protocols (e.g., HTTP).

While the machine-readable medium 1522 is shown in an example embodiment to be a single medium, the term “machine-readable medium” should be taken to include a single medium or multiple media (e.g., a centralized or distributed database, and/or associated caches and servers) that store the one or more sets of instructions 1524. The term “machine-readable medium” shall also be taken to include any medium that is capable of storing, encoding or carrying a set of instructions for execution by the computer and that cause the computer to perform any one or more of the methodologies of the present application, or that is capable of storing, encoding or carrying data structures utilized by or associated with such a set of instructions. The term “machine-readable medium” shall accordingly be taken to include, but not be limited to, solid-state memories, and optical and magnetic media.

While various implementations and exploitations are described, it will be understood that these embodiments are illustrative and that the scope of the claims is not limited to them. In general, techniques for maintaining consistency between data structures may be implemented with facilities consistent with any hardware system or hardware systems defined herein. Many variations, modifications, additions, and improvements are possible.

Plural instances may be provided for components, operations or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the claims. In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the claims.

While the embodiments are described with reference to various implementations and exploitations, it will be understood that these embodiments are illustrative, and that the scope of claims provided below is not limited to the embodiments described herein. In general, the techniques described herein may be implemented with facilities consistent with any hardware system or hardware systems defined herein. Many variations, modifications, additions, and improvements are possible.

The term “machine readable medium” is used generally to refer to media such as main memory 1504, secondary memory, removable storage, hard disks, flash memory, disk drive memory. CD-ROM and other forms of persistent memory. It should be noted that program storage devices, as may be used to describe storage devices containing executable computer code for operating various methods, shall not be construed to cover transitory subject matter, such as carrier waves or signals. “Program storage devices” and “machine-readable medium” are terms used generally to refer to media such as main memory 1504, secondary memory, removable storage disks, hard disk drives, and other tangible storage devices or components.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the claims. In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the claims and their equivalents.

What is claimed is:

1. A method of distributing costs in a transportation management system, the method comprising:
retrieving a charge element for a cost to be applied to a transportation invoice, wherein the charge element identifies a charge amount;
for each distribution item, creating a distribution element corresponding to the distribution item in response to a determination that the charge element is applicable to the distribution item, wherein each distribution item corresponds to an item transported in a shipment associated with the transportation invoice;
determining a quantity type identified in a distribution rule for the charge element;
obtaining quantities of the quantity type for each distribution element;
summing the quantities for all of the distribution elements to calculate an aggregate quantity; and
for each distribution element, allocating a cost for the charge element equal to a quantity of the distribution element divided by the aggregate quantity multiplied by the charge amount.

2. The method of claim 1, further comprising determining that the charge element is applicable to the distribution item when the charge element applies to a stage of the shipment in which the distribution item is transported.

3. The method of claim 1, further comprising:
identifying a resolution base of the charge element and a calculation level; and
determining that the charge element is applicable to the distribution item based on the resolution base and the calculation level.

4. The method of claim 3, wherein the determining that the charge element is applicable includes:
identifying all distribution items traveling to a stage in which the charge element refers, in response to a determination that the resolution base is at a stage level or that the calculation level is at the stage level;
identifying all distribution items, in response to a determination that the resolution base is at a root level and that the calculation level is at a header level; and
identifying all distribution items within a hierarchy of an item to which the charge element refers, in response to a determination that the resolution base is at the root level and that the calculation level is at an item level.

5. The method of claim 1, wherein the quantity type is weight and the quantities for each of the distribution elements are weights of items corresponding to the distribution elements.

6. The method of claim 1, further comprising:
designating one or more parent items of distribution items in a hierarchy as transient distribution items;
performing the retrieving, creating, determining, obtaining, summing, and allocating at a first level of the hierarchy to assign costs to each of the transient distribution items; and
performing the retrieving, creating, determining, obtaining, summing, and allocating at a second level of the hierarchy by assigning costs from each of the transient distribution items to distribution items at the second level of the hierarchy.

7. A system comprising:
a processor;
a memory storing a host business object, a data access object, and a cost distribution dependent object, the host business object designed to, when instantiated by the processor, trigger an action to distribute transportation costs, retrieve freight information from the data access object, and pass freight information to the cost distribution dependent object, the cost distribution dependent object designed to, when instantiated, for each distribution item, create a distribution element corresponding to the distribution item in response to a determination that a charge element is applicable to the distribution item, wherein each distribution item corresponds to an item transported in a shipment associated with a transportation invoice;
a cost distribution engine designed to:
determine a quantity type identified in a distribution rule for the charge element;
obtain quantities of the quantity type for each distribution element;
sum the quantities for all of the distribution elements to calculate an aggregate quantity; and
for each distribution element, allocate a cost for the charge element equal to a quantity of the distribution element divided by the aggregate quantity multiplied by the charge amount.

8. The system of claim 7, wherein the system is contained in a transportation management component.

9. The system of claim 8, wherein the transportation management component interfaces with an Enterprise Resource Planning (ERP) system.

10. The system of claim 7, wherein the cost distribution dependent object is further designed to, upon instantiation, identify a resolution base of the charge element and a calculation level; and
determine that the charge element is applicable to the distribution item based on the resolution base and the calculation level.

11. The system of claim 10, wherein the determining that charge element is applicable includes:
identifying all distribution items traveling to age in which the charge element refers, in response to a determination that the resolution base is at a stage level or that the calculation level is at a stage level;
identifying all distribution items, in response to a determination that the resolution base is at a root level and that the calculation level is at a header level; and
identifying all distribution items within a hierarchy of an item to which the charge element refers, in response to a determination that the resolution base is at a root level and that the calculation level is at an item level.

12. The system of claim 7, wherein the quantity type is weight and the quantities for each of the distribution elements are weights of items corresponding to the distribution elements.

13. The system of claim 7, wherein the cost distribution engine is further designed to:
designate one or more parent items of distribution items in a hierarchy as transient distribution items;
perform the retrieving, creating, determining, obtaining, summing, and allocating at a first level of the hierarchy to assign costs to each of the transient distribution items; and
perform the retrieving, creating, determining, obtaining, summing, and allocating at a second level of the hierarchy by assigning costs from each of the transient distribution items to distribution items at the second level of the hierarchy.

14. The system of claim 7, wherein the host business object is located in an ERP system and the cost distribution engine is located in a transportation management component.

15. A non-transitory computer-readable storage medium comprising instructions that, when executed by at least one processor of a machine, cause the machine to perform operations distributing costs in a transportation management system, the method comprising:
retrieving a charge element for a cost to be applied to a transportation invoice, wherein the charge element identifies a charge amount;
for each distribution item, creating a distribution element corresponding to the distribution item in response to a determination that the charge element is applicable to the distribution item, wherein each distribution item corresponds to an item transported in a shipment associated with the transportation invoice;
determining a quantity type identified in a distribution rule for the charge element;
obtaining quantities of the quantity type for each distribution element;
summing the quantities for all of the distribution elements to calculate an aggregate quantity; and
for each distribution element, allocating a cost for the charge element equal to a quantity of the distribution element divided by the aggregate quantity multiplied by the charge amount.

16. The non-transitory computer-readable storage medium of claim 15, further comprising determining that the charge element is applicable to the distribution item when the charge element applies to a stage of the shipment in which the distribution item is transported.

17. The non-transitory computer-readable storage medium of claim 15, further comprising:
identifying a resolution base of the charge element and a calculation level; and
determining that the charge element is applicable to the distribution item based on the resolution base and the calculation level.

18. The non-transitory computer-readable storage medium of claim 17, wherein determining that the charge element is applicable includes:
identifying all distribution items traveling to a stage to which the charge element refers, in response to a determination that the resolution base is at a stage level or that the calculation level is at a stage level;
identifying all distribution items, in response to a determination that the resolution base is at a root level and that the calculation level is at a header level; and
identifying all distribution items within a hierarchy of an item to which the charge element refers, in response to a determination that the resolution base is at a root level and that the calculation level is at an item level.

19. The non-transitory computer-readable storage medium of claim 15, wherein the quantity type is weight and the quantities for each of the distribution elements are weights of items corresponding to the distribution elements.

20. The non-transitory computer-readable storage medium of claim 15, further comprising:
designating one or more parent items of distribution items in a hierarchy as transient distribution items;
performing the retrieving, creating, determining, obtaining, summing, and allocating at a first level of the hierarchy to assign costs to each of the transient distribution items; and
performing the retrieving, creating, determining, obtaining, summing, and allocating at a second level of the hierarchy by assigning costs from each of the transient distribution items to distribution items at the second level of the hierarchy.
